(19) United States
(12) Patent Application Publication
(10) Pub. No.: US 2007/0178244 A1
(43) Pub. Date: Aug. 2, 2007

(54) Resin coating method and apparatus

(75) Inventors: Mikihiro Torii, Kariya-city (JP); Shusaku Nakazawa, Obu-city (JP); Kazuhiro Aoyama, Nagoya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/699,981

(22) Filed: Jan. 30, 2007

(30) Foreign Application Priority Data
Jan. 31, 2006 (JP) 2006-022455

(51) Int. Cl. B05D 1/18; B05C 3/02

(52) U.S. Cl. 427/430.1; 118/423

(57) ABSTRACT

A resin coating apparatus includes a feed tank 2 for feeding a coating material 9 to a coating tank 1 and an extraction cylinder apparatus 3 for extracting the coating material inside the coating tank 1 and returning the coating material extracted to the feed tank in addition to the coating tank 1 for immersing a work 10. The coating material compulsively extracted from the coating tank in which the work 10 is immersed. The extraction cylinder apparatus has a speed regulation apparatus 4 and the extraction speed of the coating material is regulated in accordance with the shape of the work.

### BACKGROUND OF THE INVENTION

1. Field of the Invention

This invention relates to a resin coating method for coating a resin material onto a surface of an article to be coated (coated article) and an apparatus for the method.

2. Description of the Related Art

To apply a resin material to a surface of a work as a coated article, it has been customary to employ a method that involves the steps of immersing the work into an immersion tank 20 storing a liquid coating material, prepared by dissolving a resin material in a solvent, as shown in FIGS. 6A and 6B (see FIG. 6A), leaving the work standing under this condition for a predetermined time, pulling the work out from the tank 20 and draining the coating material using an air blow apparatus 30 (see FIG. 6B).

In the case of a work formed by mounting a semiconductor chip 12 to a heat radiation plate 11 with a small gap g between them and connecting them by connecting members 13 in such a manner as to face each other, the coating material of the gap g cannot be drained uniformly by air blow. Therefore, a method that leaves the work standing for a long time after the work is taken out from the immersion tank 20 for immersion application has been employed. This method involves the problem that the draining time is long.

Another known method dries the work by lowering the liquid level of the coating material after the work 10 is immersed in the immersion tank 20 storing the coating material. A thin film formation method, as an improvement of this method, is described in Japanese Unexamined Patent Publication No. 2001-58149.

This known method permits the liquid level of the coating material in the immersion tank 20 after the work 10 is immersed in the coating material for the predetermined time, to lower by gravitational force alone and uses a valve controller for controlling the liquid level lowering speed of the immersion tank 20. However, because this method uses only gravitational force for lowering of the liquid level of the coating material, that is, its own weight, the method is not free from the problem that a liquid draining time is long when the viscosity of the coating material is as high as 200 mPa·s, for example, though the method can execute the speed control of liquid draining through opening adjustment of a discharge valve of the coating material.

All these prior art methods described above involve the problem that the liquid draining time (the time in which the work is left standing) becomes long. When the resin material is water absorptive, the problem of denaturing of the material while it is left standing occurs. Therefore, an environment in which the work is left standing is kept in a nitrogen atmosphere and the apparatus becomes large in scale.

Furthermore, because the resin is solidified while it is left standing, the coating thickness of the coating material on the work is not stable.

### SUMMARY OF THE INVENTION

In view of the problems described above, the present invention is directed to provide a resin coating method capable of applying thinly uniformly and within a short time a resin material to a coated article, particularly a coated article having two faces so arranged in parallel as to face each other, and a resin coating apparatus for the method.

A resin coating method according to the present invention transfers a coated article 10 into a coating tank 10, immerses the coated article into a coating material 9 for a predetermined time, compulsively extracting the coating material from the coating tank 1 by coating material extraction means and thus applies the coating material 9 to the coated article 10. It becomes thus possible to apply thinly uniformly and within a short time the coating material to the coated article 10.

A resin coating method according to the present invention comprises an initial step of transferring a coated article 10 into a coating tank 1 by the coated article transfer means, a coating material feeding step of feeding the coating material 9 from the feeding tank 2 into the coating tank 1 and immersing the coated article 10 into the coating material 9, a coating material applying step of extracting the coating material 9 from the coating tank 1 and a coating material recovering step of taking out the coated article 10 from the coating tank 1 by the coating material transfer means and returning the coating material 9 to the feeding tank 2 from the coating material extraction means.

A resin coating apparatus according to the present invention comprises a feed tank 2 for feeding the coating material 9 into a coating tank 1 and an extraction cylinder apparatus 3 for extracting the coating material 9 from the coating tank 1 and returning the coating material 9 extracted into the feeding tank 2 besides a coating tank 1 for immersing a coated article 10, and compulsively extracts the coating material 9 from the coating tank 1. This apparatus invention is a mere conversion of the invention of the method to an apparatus invention and its function and effect is substantially the same as that of the method invention.

A resin coating apparatus according to the present invention further comprises a speed regulation apparatus 4 for regulating an extraction speed of the coating material 9 in the extraction cylinder apparatus 3, and can regulate the extraction speed in accordance with the shape of the coated article 10. Accordingly, the coating material 9 can be applied stably and at a high speed to the coated article 10 having any shape. The coating thickness can be arbitrarily set by changing the extraction speed.

A resin coating apparatus according to the present invention further comprises temperature stabilization means lest the viscosity of the coating material 9 changes during the application operation. Accordingly, the viscosity of the coating material 9 can be kept substantially constant and the coating material 9 can be uniformly applied to the coating article 10.

A resin coating apparatus according to the present invention specifies that the coated article 10 has two surfaces so arranged in parallel as to face each other with a gap between them. The invention is particularly effective for such a coated article.

The present invention will be more fully understood from the description of preferred embodiments of the invention, as set forth below, together with the accompanying drawings.

### BRIEF DESCRIPTION OF THE DRAWINGS

In the drawings:

FIG. 1 is an explanatory view for explaining an overall construction of a resin coating apparatus according to an embodiment of the invention;

FIG. 2 is an explanatory view for explaining coating steps (a) to (d) as the operation of the resin coating apparatus (resin coating method) according to the embodiment of the invention;

FIG. 3 is an explanatory view for explaining the operation of the resin coating apparatus according to the invention;

FIG. 4A is a graph for explaining the coating operation according to the invention and FIG. 4B is an explanatory view for explaining adjustment of an extraction speed of a coating material;

FIG. 5 is a sectional view and a side view each for explaining a work suitable for the resin coating method according to the invention; and

FIGS. 6A and 6B are explanatory views for explaining a resin coating method according to the prior art.

### DESCRIPTION OF THE PREFERRED EMBODIMENTS

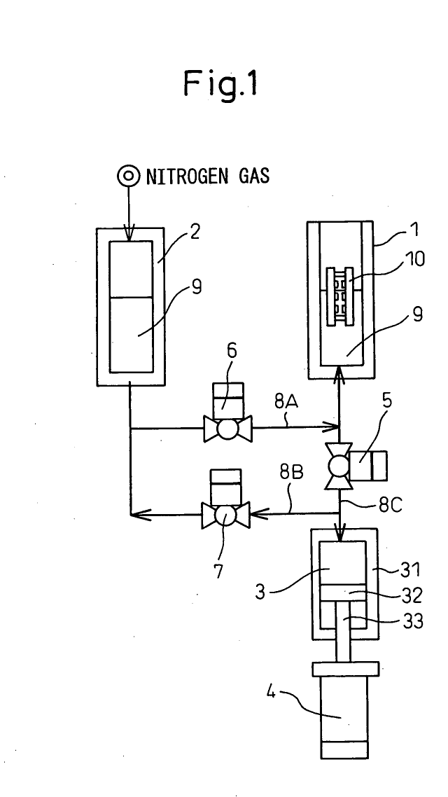

A resin coating method and a resin coating apparatus according to preferred embodiments of the invention will be hereinafter explained with reference to the accompanying drawings. FIG. 1 is a schematic view showing an overall construction of a resin coating apparatus according to an embodiment of the invention. In the drawing, reference numeral 1 denotes a coating tank, which is open at its upper part. A work 10 as a material to be coated is carried into and out from the coating tank 1 by coated article transfer means not shown in the drawing.

The coating tank 1 is connected to a feed tank 2 through a feed piping 8A equipped with a feed valve 6. A liquid coating material 9 prepared by dissolving a resin material in a solvent is supplied from the feed tank 2 into the coating tank 1 through the feed valve 6. Though FIG. 1 shows only one feed tank 1, it is possible to combine a plurality of coating tanks 1 for one feed tank 2. The feed tank 2 is a sealed tank and a nitrogen gas (N₂) is introduced from a nitrogen gas source. An inert gas not containing moisture and other impurities can be used in place of the nitrogen gas.

A temperature adjustment jacket (not shown) as temperature stabilization means for controlling the coating material 9 to a predetermined temperature is provided to the feed tank 2 lest the viscosity of the coating material 9 changes. The temperature adjustment jacket may be provided to the coating tank 1.

The coating tank 1 is further connected to an extraction cylinder apparatus 3 through an extracting piping arrangement 8C equipped with an extracting valve 5. The extraction cylinder apparatus 3 includes a cylinder portion 31, a piston portion 32 and a rod 33 interconnected to the piston portion 32. When the piston portion 32 (rod 33) is pulled down in FIG. 1, the coating material 9 inside the coating tank 1 is withdrawn into the extracting cylinder apparatus 3 through the extracting piping arrangement 8C. One of the ends of the rod 33 is connected to the piston portion 32 and the other end, to a speed regulation apparatus 4. The speed regulation apparatus 4 may use any mechanism so long as it can cause linear reciprocation of the rod 33, such as a fluid cylinder mechanism, a rack and pinion mechanism, and ball and screw mechanism. The extracting speed is determined depending on the moving speed of the rod 33. Therefore, the extracting speed can be regulated by changing the moving speed of the rod 33.

The extraction cylinder apparatus 3 is connected to the feed tank 2 through a recovery piping arrangement 8B having a recovery valve 7. Therefore, the coating material withdrawn from the coating tank 1 to the extraction cylinder apparatus 3 can be recovered to the feed tank 2 when the piston portion 32 of the extraction cylinder apparatus 3 is pushed up in FIG. 1.

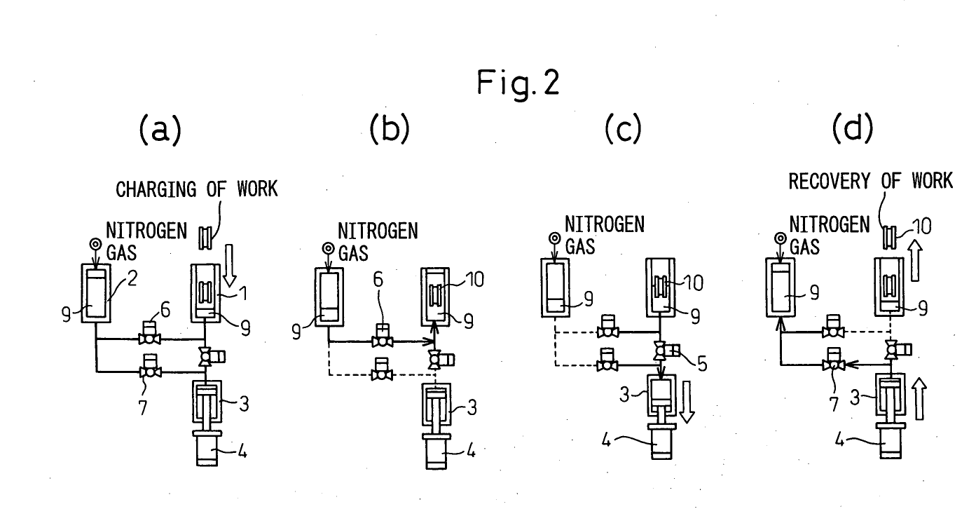

The operation of the resin coating apparatus (coating method) of this embodiment having the construction described above will be explained with reference to FIG. 2. FIGS. 2(a) to 2(d) show the coating steps. To begin with, in the initial state shown in FIG. 2(a), the coating material 9 fills the feed tank 2 and remains only slightly in the coating tank 1. Under this state, the work 10 is put into the coating tank 1 by the coated article transfer means (not shown). In this case, the valves 5, 6 and 7 are all closed and the piston portion 32 of the extraction cylinder apparatus 3 is at the ascension position.

Next, as shown in the coating material feeding step of FIG. 2(b), the feed valve 6 is opened and, at the same time, the nitrogen gas is introduced into the feed tank 2. The internal pressure of the feed tank 2 is elevated by the introduction of the nitrogen gas, pushes the coating material 9 and transfers it to the coating tank 1. In consequence, the work 10 in the coating tank 1 is immersed in the coating material 9. In this instance, the inside of the coating tank 1 may be brought to a vacuum, whenever necessary. After the work 10 is immersed in the coating material 9, the feed valve 6 is closed and the supply of the nitrogen gas is stopped. The work 10 is kept immersed in the coating material 9 for a predetermined time.

After the work 10 is kept immersed in the coating material 9 for the predetermined time, the extracting valve 5 is opened and the piston portion 32 of the extraction cylinder apparatus 3 moves down at a speed set by the speed regulation apparatus 4 as shown in the coating step of FIG. 2(c) and the coating material 9 inside the coating tank 1 is compulsively withdrawn into the cylinder portion 31 of the extraction cylinder apparatus 3. This descending operation (coating material drawing operation) is continued until the work 10 inside the coating tank 1 exists completely above the liquid surface of the coating material 9 (under the condition where it is released from immersion). The descending operation of the piston portion 32 is stopped when the work 10 is released from immersion of the coating material 9 and the extracting valve 5 is closed. As the cylinder apparatus 3 is operated in this way, the coating material 9 is compulsively drawn from the coating tank 1 owing to the capacity change inside the cylinder and is applied to the surface of the work 10.

Next, the recovery valve 7 is opened as shown in the coating material recovery step shown in FIG. 2(d) and the piston portion 32 of the extraction cylinder apparatus 3 is moved up from the down position while the pull-up speed is regulated by the speed regulation apparatus 4. Consequently, the coating material 9 pulled out from the coating tank 1 and existing inside the extraction cylinder apparatus 3 is pushed up and is transferred into the feed tank 2. The piston portion 32 moves up to the initial up position, and the coating material 9 pulled out from the coating tank 1 is recovered into the feed tank 2. In this case, the nitrogen gas inside the feed tank 2 is either returned to the nitrogen gas source or is discharged outside the feed tank 2. The work 10 inside the coating tank 1 is taken out by the transfer means.

As a result of a series of operations described above, the coating material 9 is applied thinly and uniformly to the work 10 within a short period.

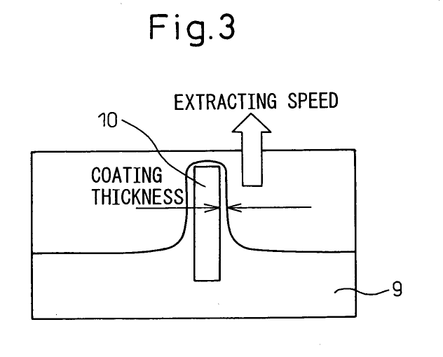

FIG. 3 is a view for explaining the function and effect of the present invention. It is known that generally, the thickness of a liquid adhering to the surface of an article (work) when the article is pulled out from the liquid (coating material) is proportional to the pull-up speed. In other words, the film is thin when the work is pulled out slowly and becomes thick when pulled out at a high speed. When a coating material having a viscosity of 200 mPa·s is pulled out at a speed of 5 mm/sec, for example, a uniform coating thickness of 200 μm can be acquired.

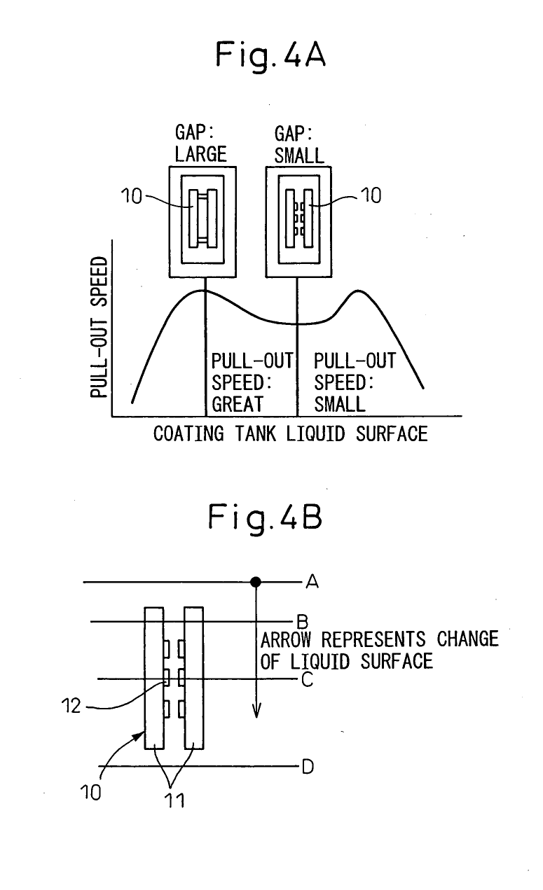

FIG. 4 is a graph for explaining the coating operation. The abscissa represents the change of the liquid surface of the coating tank and the ordinate represents the pull-out speed of the coating material. A curve inside the graph represents that the pull-out speed is changed for each position of the liquid level when the liquid (coating material) is pulled out, for example. In other words, the curve shows that the pull-out speed is increased when the clearance of the work is great and is decreased when the clearance of the work is small.

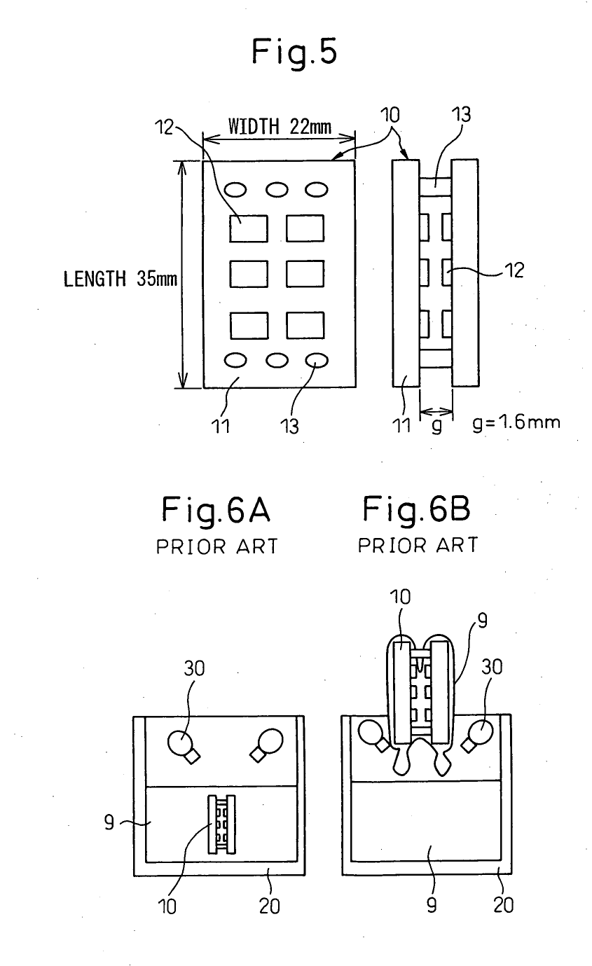

FIG. 4B is a view for explaining the adjustment of the drawing speed of the coating material when the coating material 9 is applied to the work as the same parallel component shown in FIG. 5, for example. In the work 10 in which IC chips (semiconductor devices) are bonded to the inner side, for example, a gap g is large between substrates (heat radiation plates) 11 to which the IC chips 12 are not bonded but is small at the portions at which the IC chips 12 are bonded because the portion between the IC chips 12 is the gap g. Therefore, an optimal application can be done even in works having complicated shapes when an optimal drawing speed is selected for each gap g (programming is made in advance by sequence, for example).

In other words, in FIG. 4B, drawing by the extraction cylinder apparatus 3 is started at the point A at a low speed, the speed shifts to a drawing speed corresponding to the width at the point B because the gap of the work is wide and is lowered at the point C because the gap becomes narrow. The point D is the liquid surface at which the work 10 does not exist. Therefore, drawing is made within the range where foaming of the eluted gas in the coating material 9 due to drawing is not affected.

It becomes possible in this way to optimize the drawing speed for each part of the work 10 and to shorten the processing time.

As described above, the cylinder is operated at a speed to match the gap to compulsively drain the resin (coating material) from the work surface in accordance with the capacity change, and the resin can be recovered without interruption from the work surface.

While the invention has been described by reference to specific embodiments chosen for purposes of illustration, it should be apparent that numerous modifications could be made thereto, by those skilled in the art, without departing from the basic concept and scope of the invention.

1. A resin coating method using a coating apparatus including:
a coating tank for immersing an article to be coated into a liquid coating material containing a resin material;
a feed tank for feeding said coating material into said coating tank;
coated article transfer means for transferring said article to be coated into said coating tank and taking it out therefrom; and
coating material extraction means for extracting said coating material inside said coating tank; and wherein
said resin coating method transfers the article to be coated into said coating tank, immerses said article to be coated in said coating material for a predetermined time and applies said coating material to said article to be coated by compulsively extracting said coating material from said coating tank by said coating material extraction means.

2. A resin coating method according to claim 1, which said resin coating method comprises:
an initial step of transferring said article to be coated into said coating tank by said coated article transfer means;
a coating material feeding step of feeding said coating material from said feeding tank into said coating tank and immersing said article to be coated into said coating material;
a coating material applying step of extracting said coating material from said coating tank by said coating material extraction means after being kept immersing in said coating material for the predetermined time; and
a coating material recovering step of taking out said article to be coated from said coating tank by said coating material transfer means and returning said coating material from said coating material extraction means to said feeding tank.

3. A resin coating apparatus for applying a coating material to an article to be coated comprising:
a coating tank for immersing an article to be coated into a liquid coating material containing a resin material;
coated article transfer means for transferring said article to be coated into said coating tank and taking it out therefrom;
a feed tank for feeding said coating material into said coating tank; and
a drawing cylinder apparatus for drawing said coating material in said coating tank and returning said coating material drawn into said feed tank; and wherein
said coating material is compulsively extracted from said coating tank.

4. A resin coating apparatus according to claim 3, which further comprises a speed regulation apparatus for regulating an extraction speed of said coating material in said extraction cylinder apparatus, and regulates the extraction speed to match the shape of said coated article.

5. A resin coating apparatus according to claim 3, which further comprises temperature stabilization means so that the viscosity of said coating material does not change during the application operation of said resin coating apparatus.

6. A resin coating apparatus according to claim 3, wherein said article to be coated has two surfaces, facing each other, so arranged as to be parallel to each another with a gap between them.
